(19) United States
(12) Patent Application Publication
(10) Pub. No.: US 2016/0265844 A1
(43) Pub. Date: Sep. 15, 2016

(54) PROCESS FOR CONTROLLING THE QUALITY OF A FREEZE-DRYING PROCESS

(71) Applicant: LABORATORIO REIG JOFRÉ, S.A., San Joan Despí (ES)

(72) Inventors: Enrique JO CARDOSO, BARCELONA (ES); Sasa NIKOLIC, CORNELLA DE LLOBREGAT (ES)

(73) Assignee: LABORATORIO REIG JOFRE, S.A., SANT JOAN DESPI (ES)

(21) Appl. No.: 15/034,850

(22) PCT Filed: Nov. 26, 2014
(86) PCT No.: PCT/EP2014/075632

§ 371 Date: May 5, 2016

(30) Foreign Application Priority Data
Nov. 27, 2013 (EP) 13382473.0

(51) Int. Cl. F26B 5/06

(52) U.S. Cl. CPC F26B 5/06

(57) ABSTRACT

Method for controlling the quality of a freeze-drying process includes the steps of defining a set of experiments by statistical design of experiments; performing freeze-drying processes of a product for each one of the experiments; obtaining a dataset of pressures and temperatures from the freeze dryer, the dataset comprising at least one combined parameter; removing noise intrinsic to the measurements; performing a PCA to obtain a fingerprint of the lyophilization process for each one of the experiments; and selecting a range of fingerprints in which a specific product batch will be within specifications. Also provided is a process for controlling the quality of a freeze-drying process which comprises: performing the freeze-drying process at the temperature and pressure set points of the optimal process; obtaining a fingerprint of the process; and using the range of fingerprints obtained above to assess whether the product batch is within specifications.

The invention relates to a method for controlling a freeze-drying process. In particular it refers to a method for monitoring the critical output parameters obtained from a freeze dryer during a freeze drying process to ensure the quality of the process and, as a consequence, of the freeze dried product obtained therefrom.

### BACKGROUND ART

The manufacture of pharmaceutical products is highly regulated, nationally and internationally. Therapeutic efficacy and patient safety of finished pharmaceutics is traditionally guaranteed by process validation, usually three consecutive industrial scale batches, stability studies data, and testing of the quality attributes of the samples of each commercial batch. This approach is based on an assumption that a validated process never changes, that the raw and ancillary materials are of same quality throughout the life cycle of a product, and that the same set up for a freeze dryer replies, batch to batch, exactly the same response.

Freeze-drying, also known as lyophilization, is a process that removes the solvent from a material to a level where the product shows significantly increased stability. The process has applications in the preservation of many different types of materials, such as pharmaceuticals and biological products.

Freeze drying is a linear process comprising three phases: freezing of the product, primary drying of the frozen material (by a process known as sublimation), and secondary drying (where water which is chemically bound is removed (desorption)). It is a highly complex process with many interacting variables. Usually, the main focus is on shelf temperature and chamber pressure as set up process parameters. Nevertheless, the output of the process (output parameters) is a result of interaction of those and many other parameters in all the phases of the process. This interaction is often poorly understood. As a result, process quality controls usually rely on individually controlling some of the parameters at or near the defined point. However, not all the changes will have the same impact on the process. Furthermore, the quality control of the finished freeze dried products taking into account just several samples, out of thousands that are produced in the same batch, may not be enough to guarantee the safety and the quality of the product given to the patient. The main reason for the latter is the lack of uniformity of energy and mass transfer in a freeze drying chamber that is depending on the geometry of the freeze dryer and the little variations in the energy transfer generated by the external systems related with cooling and heating; as well as differences in nucleation speed and ice crystal formation. As a consequence, there can be significant differences among vials in different positions in the freeze dryer. Another important factor is the variability in performance of the freeze dryer's parts such as vacuum pumps and compressors that control the temperature of the condenser, both of them driving forces for sublimation. Additionally, the variability of the active pharmaceutical ingredient and excipients quality can also influence the outcomes of the production process; although in lesser extent than in case of other pharmaceutical dosage forms because prior to freeze drying, the solid ingredients are dissolved.

WO2007018868 discloses a method for monitoring and controlling a bioprocess. Nevertheless, no specific information is provided on their application to a freeze-drying process.

WO2011077390 discloses a method for monitoring a primary drying phase of a freeze-drying process in a freeze-drying apparatus. This method is able to monitor only one of the three stages of the freeze-drying process, namely the primary drying. So, the results are not obtained from comprehensive datasets of the whole process method.

From the above, it can be seen that there exists a need for a method that allows predicting the quality of a freeze dried product by controlling the quality of a freeze-drying process and without the need of analyzing the final product.

### SUMMARY OF THE INVENTION

Inventors have found that by performing a multivariate analysis of certain parameters of a freeze-drying process, the quality of both the process and the freeze dried product can be predicted with a high reliability by creating a process fingerprint.

Accordingly, one aspect of the invention is a method for obtaining a range of fingerprints defining the quality of a freeze-drying process, comprising the steps of:
i) providing a product to be freeze dried;
ii) fixing the temperature and pressure set points for the freeze drying process;
iii) defining a set of experiments by statistical design of experiments (DoE) for the process of step ii) in order to introduce variability in the process and to study their influence on the quality of the obtained freeze dryed product;
iv) performing a freeze drying process of the product of step i) for each one of the experiments defined in step iii) using a freeze dryer;
v) obtaining a dataset of pressures and temperatures from the freeze dryer and, optionally, from at least one probe measuring additional information about the process or the product, wherein the dataset of pressures and temperatures from the freeze dryer comprises at least one combined parameter;
vi) removing noise intrinsic to the measurements from the dataset in order to obtain smoothed data by using computational methods, and scaling the smoothed data;
vii) performing a first multivariate analysis on the smoothed and scaled data by using Principal Component Analysis (PCA) to obtain a first set of principal components;
viii) analyzing the first set of principal components in order to select a set of parameters by eliminating parameters with loading values close to zero and parameters having the same loading value as another parameter, and carrying out a second multivariate analysis by using PCA on the selected parameters to obtain a second set of principal components;
ix) selecting the number of principal components explaining a variance equal to or higher than 95% of the total variance of the dataset to obtain a fingerprint of the freeze drying process for each one of the experiments carried out in step iii);
x) analyzing the quality of the freeze dryed product obtained by each one of the experiments carried out in step iii) in order to see if the product is within specifications; and
xi) selecting the fingerprint of the optimal process, i.e. the process yielding the finished product with the best analytical profile, and the fingerprint of the process carried out at the highest temperature and pressure yielding a product within specifications, both fingerprints defining a range of fingerprints in which a specific product batch will be within specifications.

By using combined parameters, parameters that isolated have no significance gather importance when combined with others and a more robust and reliable method is achieved. Thus, the approach of the invention drastically increases the reliability of the process and reduces the time for the release of the produced batches, by means of a new system to control the variability in this type of processes. Additionally, a robust system to obtain the product within specifications without the necessity of sampling and testing for some of the critical quality attributes of the finished product itself in commercial manufacturing is also provided.

Another aspect of the invention relates to a process for controlling the quality of a freeze-drying process which comprises: a) performing the freeze drying process at the temperature and pressure set points of the optimal process; b) obtaining a fingerprint of the process by: i) carrying out a multivariate analysis by using PCA on the parameters selected in step viii) of the method defined above to obtain a set of principal components; and ii) selecting the same number of principal components as defined in step ix) of the method; and c) using the range of fingerprints obtained by the method for obtaining a range of fingerprints as defined above in order to assess whether the product batch is within specifications by comparing the fingerprint of the process and the range of fingerprints obtained by the method for obtaining a range of fingerprints as defined above.

### BRIEF DESCRIPTION OF THE DRAWINGS

FIG. 1 is a plot representing in two dimensions the contribution of several parameters and their correlation for the principal components (PC): PC1, PC2, PC3 and PC4. Regarding each PC, the further from zero the parameters are, the more contribution is given to those parameters to build de PC. Also, the closer the parameters are among them, the more correlated they are. As can be seen, the parameters TP1 and TP2, as well as TP1_TBA and TP2_TBA provide the same information. Therefore, for the process fingerprint calculation, just one of each group should be used.

FIG. 2 is a graph of explained variance, wherein the x-axis represents the principal components (PCs) and the y-axis represents the variance. It is shown that the first four PCs of the example provided by FIG. 1 explain 96% of variance contained in the experimental data set.

FIG. 3 is a three dimensional graph exemplifying the established three-dimensional space with one principal component in each axis used when an acceptable degree of variance can be defined by three principal components. Each dotted line in the graph represents one process and each point represents the fingerprint of the process at one time point. The graph represents fingerprints of 9 different processes. Those processes that yield products that meet the acceptance criteria in terms of quality represent acceptable trajectories, i.e. fingerprints of acceptable processes. In this example, parts of the fingerprint are shown as those corresponding to freezing phase, frozen product, primary drying I (PDI) phase, primary drying II (PDII) phase, and secondary drying phase (SD).

FIG. 4 is a graph exemplifying the normal operating ranges (NOR) for each of the phases of a freeze drying process.

FIG. 5 is a residual moisture content (RMC) model calibration plot

FIG. 6 shows the categories of appearance for collapse: a) unacceptable; b) poor; c) acceptable; d) correct.

### DETAILED DESCRIPTION OF THE INVENTION

In the context of the invention, the expression “chemometric” relates to measurements made on a chemical system or a process to assess the state of the system via application of mathematical or statistical methods.

In the context of the invention the expression “freeze drying process” stands for the three phases defining the process: freezing of the product, primary drying of the frozen material, and secondary drying.

In the context of the invention the expression “parameter” stands for both the inputs (set up process parameters) and the outputs (variable process parameters monitored during the process).

In the context of the invention the term “set point” stands for the value given to each of the input process parameters such as temperatures (of the freezing, primary drying, and secondary drying stages of the lyophilization process), pressure (of the primary drying of the lyophilization process), and time (of the freezing, primary drying, and secondary drying of the lyophilization process).

In the context of the invention the expression “combined parameter” stands for a parameter obtained by a mathematical transformation from the combination of two or more parameters.

In the context of the invention, the term “dataset” stands for all the data collected during a freeze drying process by the probes installed in the freeze dryer (process data), as well as all the finished product analytical data

In the context of the invention, the term “noise” stands for data irrelevant or meaningless for the process interpretation. For example, when chamber/condenser pressure control is done by valve opening/closing cycles, the fluctuations of the measured chamber pressure can be considered noise if they are within the permitted upper and lower limits.

In the context of the invention the term “scaling” stands for the treatment of data in order to give the same weight to parameters that are measured in different units.

In the context of the invention the term “fingerprint” stands for a matrix of scores obtained by a principal component analysis of the process data that have been adequately pre-treated (smoothed and scaled). The matrix has as many columns as the process parameters (direct and combined) taken into account of the principal component analysis, and as many rows as the time points when the data are collected.

In the context of the invention the term “glass transition temperature” of an amorphous material is the temperature at which the material becomes soft upon heating, namely the critical temperature at which the material changes its behavior from being “glassy’ to being ‘rubbery”.

In the context of the invention, the term “eutectic melting temperature” of a crystalline material is the temperature at which a melting of a crystalline material occurs. In the context of the invention, the crystalline material is a solid material that is formed during the freezing of a solution of one of more solutes. So, the crystalline material consists of the maximally freeze-concentrated solutes or solutes.

In the context of the invention, the term “maximally freeze concentrated solute(s)” is the solid matrix composed of the solutes concentrated between crystals of the solvent, obtained during freezing of the initial solution.

As it has been mentioned above, the method of the invention for monitoring the quality of a freeze drying process includes developing a multivariate model that can be regarded as a type of process fingerprint. The process fingerprint can only be developed empirically for each product and each freeze dryer. By an experimental assessment, variability can be introduced in the parameters of the freeze drying process and its influence on product quality attributes can be evaluated.

Freeze drying is a process that removes the solvent from a product to a level where it shows significantly increased stability. This process has application in the preservation of many different types of products, from small molecules (where the only objective is to remove the solvent), to whole organisms. So, the product to be freeze dryed includes a chemical or a pharmaceutical compound, a pharmaceutical composition, a biological product (such as enzymes, proteins, DNA, cells, and tissues), and food stuff. Particularly, the product of interest is a pharmaceutical active ingredient or a pharmaceutical composition.

The freeze drying process can be carried out on a solution or on a suspension of the product of interest. Accordingly, in a particular embodiment of the method of the invention, the product is provided in the form of a solution or in the form of a suspension.

When the freeze drying process is carried out with a compound in solution, the following thermal parameters defining the critical material attributes can be determined: the total solidification temperature; the glass transition temperature in the case of an amorphous compound, or alternatively, the eutectic melting temperature in the case of a crystalline compound; and the collapse temperature of the maximally freeze-concentrated solute. The total solidification temperature (Tₜₛ) is obtained by means of differential scanning calorimetry (DSC). The glass transition temperature (T_{g′}) and the eutectic melting temperature (Tₑᵤ) are obtained by means of DSC. The amount of product as well as the conditions (range of temperatures and heating rate) to carry out the DSC will be determined by the person skilled in the art in a case by case basis. The collapse temperature (T_{co}) is obtained by freeze drying microscopy. Conditions (pressure, temperature, and heating rate) to carry out freeze drying microscopy will be determined by the skilled person in the art by routine work.

The temperature and pressure set points for the starting of the freeze drying process can be established in accordance to the above mentioned thermal parameters that can be previously determined. So, the freezing temperature must be below the Tₜₛ, the pressure in the chamber will be below the vapor pressure of ice that corresponds to the collapse temperature, and the freeze dryer's shelves will be at a temperature that permits efficient sublimation, but without causing collapse of the product. The collapse will be produced if either the Tₑᵤ or the T_{g′} are exceeded. The shelf temperature depends on the product characteristics (solid content, fill volume, etc), vial type, freeze dryer geometry, etc, and should be optimized case by case.

In order to introduce variability in the process and to study their influence on the quality of the obtained freeze dried product, a set of experiments is defined for the freeze drying process. Each one of the processes defining the set of experiments will be carried out at a different temperature or pressure set points or both. In order to create this set of experiments a design of experiments (DoE) methodology can be used. Particularly, D-optimal DOE can be used.

By performing the freeze drying process for each one of the experiments mentioned above a dataset is obtained by measuring several parameters from the freeze dryer and, optionally, from at least one probe that may give information about the process or the product.

Noise intrinsic to the measurements is removed in order to obtain smoothed data, and then the smoothed data are scaled in order to obtain comparable data. This data transformation is done in order to be able to carry out the treatment of the data by multivariate analysis by means of Principal Component Analysis (PCA).

After a first multivariate analysis on the smoothed and scaled data by PCA, the obtained set of principal components is analyzed in order to select a reduced set of useful parameters, and a second PCA is carried out on the this selected set of parameters.

Then, a number of principal components explaining a variance equal to or higher than the acceptable level defined by the user, often a variance equal to or higher than 95% of the total variance of the dataset, is selected to obtain a fingerprint of the lyophilization process for each one of the experiments carried out.

The quality of the lyophilized product obtained by each one of the experiments is analyzed in order to detect the processes yielding the products within specifications, among them the optimal process and the one carried out at the most extreme conditions (at the highest temperature and pressure). In order to analyze the quality of the lyophilized product, among others, the following critical quality attributes can be analyzed for each product: residual moisture, appearance of the freeze dried product, and reconstitution time.

For each experimental freeze drying process, a process fingerprint can be created. The optimal trajectory, i.e. the fingerprint of the optimal process, will correspond to the fingerprint of the process that yields the finished product characterized by the best analytical profile. All the other processes that yield with the product within the acceptable analytical specification range will define acceptable trajectories. Any excursion from the optimal trajectory that does not overpass the area defined by the acceptable trajectories will yield with a freeze dried product that complies with the specifications. For such a product it wouldn't be necessary to perform an end product quality control (at least for the specifications provided from the proposed prediction system). Acceptable trajectories will be defined by the range defined by the fingerprint of the optimal process and the fingerprint of the process carried out at the highest temperature and pressure yielding a product within specifications.

Finally, the degree of match between the fingerprint of a commercial process, i.e. a process yielding a product batch, and the fingerprint of the optimal process is calculated. When the calculated degree of match between the fingerprint of a commercial process and the fingerprint of the optimal process is within the range defined by the fingerprint of the optimal process and the fingerprint of the process carried out at the most extreme conditions, the commercial process will result with a finished product within specifications, without the need of analyzing it.

Accordingly, in a particular embodiment of the first aspect of the invention, the method further comprises a step xi) of determining whether the fingerprint of a process yielding a product batch is within the range defined by the fingerprint of the optimal process and the fingerprint of the process carried out at the highest temperature and pressure yielding a product within specifications, in order to assess whether the product batch is within specifications. Particularly, the process yielding the product batch is carried out at the same temperature and pressure set points than the ones of the optimal process.

As mentioned above, the process fingerprint can be derived from a comprehensive dataset obtained by measuring several parameters from the freeze dryer. These parameters are based on sensor data directly collected from the process units of the freeze dryer, such as: pressure value at pump port, chamber pressure (measured by two different types of vacuum gauges, particularly by capacitance gauge and by Pirani gauge, the latter being sensitive to the presence of moisture), shelf thermal fluid inlet and outlet temperatures, condenser inlet and outlet temperatures, shelf surface temperature, product temperature (measured by at least one temperature probe), and dew point temperature.

Besides to the dataset directly obtained from the process units of the freeze dryer, the method of the invention comprises at least one combined parameter, such as: the difference between shelf and product temperatures; the difference between condenser inlet and outlet temperatures; the difference between shelf thermal fluid inlet and outlet temperatures; the ratio between the chamber pressure values measured by two types of gauges; the difference, relative to the chamber pressure value measured by a Pirani gauge, between the chamber pressure value measured by one capacitance gauge and the chamber pressure value measured by a Pirani type gauge; the ratio between the pressure at pump port and the chamber pressure; the difference, relative to the chamber pressure value measured by a Pirani gauge, between the pressure at pump port and the chamber pressure; and the difference between the chamber pressure values measured by two types of gauges.

Additionally, it is possible to include more types of probes associated to the freeze dryer, such as near infrared (NIR) probes (measuring physicochemical changes in a product), tunable diode laser (TDLAS; measuring the mass flow from the freeze drying chamber to the condenser), and any other probe that may give information about the process or the product.

In a particular embodiment of the method of the invention, optionally in combination with one or more features of the particular embodiments defined above or below, the at least one combined parameter is selected from the group consisting of: the difference between shelf and product temperatures; the difference between condenser inlet and outlet temperatures; the difference between shelf thermal fluid inlet and outlet temperatures; the difference, relative to the chamber pressure value measured by a Pirani gauge, between the chamber pressure value measured by one capacitance gauge and the chamber pressure value measured by a Pirani type gauge; the ratio between the pressure at pump port and the chamber pressure; the difference, relative to the chamber pressure value measured by a Pirani gauge, between the pressure at pump port and the chamber pressure; and the difference between the chamber pressure values measured by two types of gauges. More particularly, the at least one combined parameter in step v) is the ratio between the chamber pressure values measured by two types of gauges.

In a more particular embodiment of the method of the invention, optionally in combination with one or more features of the particular embodiments defined above or below, the dataset obtained from the freeze dryer comprises all the combined parameters above mentioned.

In a still more particular embodiment, optionally in combination with one or more features of the particular embodiments defined above or below, the pressure at pump port and the chamber pressure in the ratio between the pressure at pump port and the chamber pressure, the ratio between the pressure at pump port and the chamber pressure relative to chamber pressure, are measured by a Pirani type gauge.

In a still more particular embodiment, optionally in combination with one or more features of the particular embodiments defined above or below, the dataset of pressures and temperatures obtained from the freeze dryer (step v)) further comprises the following parameters: chamber pressure measured by two different types of gauges, shelf thermal fluid inlet temperature, and product temperature measured by at least one temperature probe. More particularly, the dataset step v) further comprises the following parameters: pressure at pump port, shelf thermal fluid outlet temperature, condenser inlet and outlet temperatures, and shelf surface temperature. Even more particularly, the dataset of step v) further comprises the dew point temperature.

The chamber pressure measured by at least two different types of vacuum gauges is the chamber pressure measured by capacitance gauge and the chamber pressure measured by Pirani gauge, the latter being sensitive to the presence of moisture).

In another particular embodiment the dataset is further obtained from at least one probe selected from near infrared (NIR), and tunable diode laser (TDLAS).

As mentioned above, in order to create reliable multivariate models, unwanted information, i.e. noise from the obtained data intrinsic to the measurements, has to be removed, as much as possible, but keeping the original data structure and the inherent information (smoothing action). Different techniques are available for such purpose, among them Gaussian filtering, median filtering, moving average, and Savitzky-Golay smoothing filter. In each case, it has to be checked whether the smoothing action influences the structure of the information. The easiest way is to graphically compare the original and transformed data. That means, regarding to the aspect of the graphic for the transformed data, to verify that no changes in the trends, or new inflexion points, or changes in the direction of the slopes between existing inflexion points are taking place.

Among the smoothing techniques, one appropriate for temperature and pressure data is Savitzky-Golay algorithm (cf. A. Savitzky, et al. “Smoothing and differentiation of data by simplified least squares procedures” Anal. Chem., 1964, Vol. 36, pp. 1627-1639; J. Steinier, et al. “Comments on smoothing and differentiation of data by simplified least square procedure”, Anal. Chem., 1972, Vol. 44, pp. 1906-1909). The Savitzky-Golay algorithm fits a polynomial to each successive curve segment, thus replacing the original values with more regular variations. The user chooses the length of the smoothing replacement and the order of the polynomial. Different polynomial orders and different number of points can be applied, where the choice is based on the type of data to be treated. Pressure and temperature data have different types of noise, especially if the chamber pressure is controlled by a pump-condenser valve. If this is the case, a polynomial transformation of first order can be applied to pressure data. A polynomial transformation of second order is suitable for temperature data.

The smoothed data maintain their original units, such as degrees (temperatures) and mbar (pressures). If such data are directly treated by multivariate analysis, the temperature data may be recognized as responsible of the variability, just because their values are higher. Therefore, it is necessary to give the same weight for all the data when comparing the different parameters, namely to scale the smoothed data. This scaling removes the original units, but maintains the structure of the original data set. It is done by replacing each original value of each parameter by a calculated value. This calculated value is obtained by subtracting the average value of the column (one parameter in one column) from each original value and dividing the obtained number by the standard deviation of each column.

Multivariate analysis is performed on smoothed and scaled data using Principal Component Analysis (PCA). For both, pre-treatment and PCA, commercial software is available, such as Unscrambler® X from CAMO Software AS (Oslo, Norway). The PCA technique is based on the reduction of dimensionality present in the data, while retaining as much of the variation contained in the original data set as possible. This allows retrieving relevant information hidden in the massive amount of data. It is made transforming the original measured parameters into vectors called principal components. For example, a data matrix A×N (A=number of parameters; N=number of observations) is transformed by PCA to yield with B×N (B=calculated principal components (PC)), where B<<A.

After carrying out a first PCA, all those parameters with loading values close to 0 are eliminated. The parameters that contain the same information have the same loading value. The process fingerprint can be calculated taking into account just one of the parameters that have the same loading values. So, once both parameters with loading values close to 0 and parameters having the same loading value as another one are eliminated, a selected set of parameters is obtained. Then, a new model can be calculated, namely a second PCA is carried out on the selected parameters in order to obtain the fingerprint of the process.

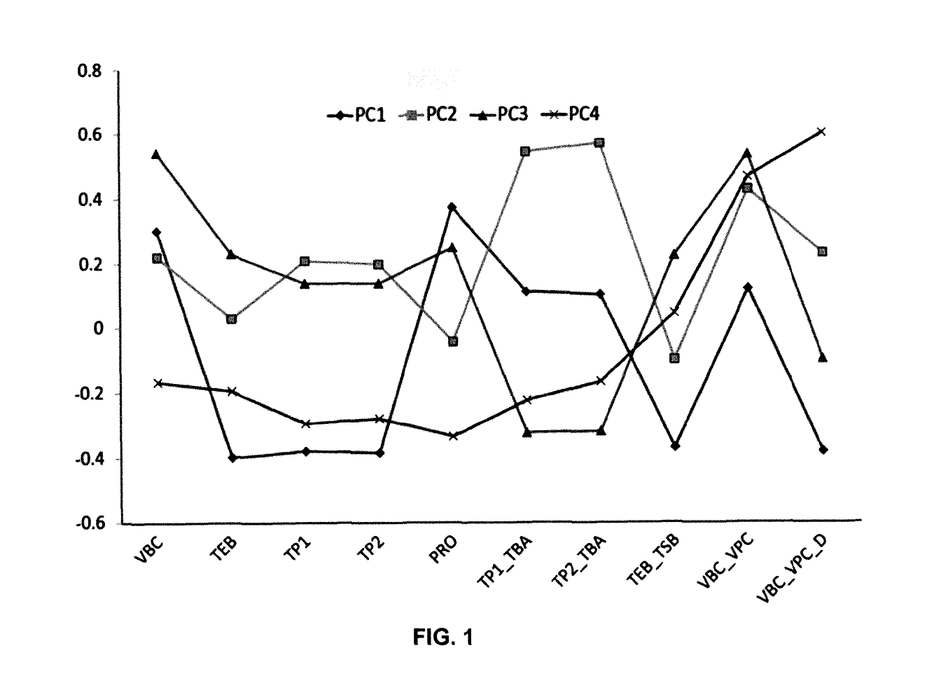

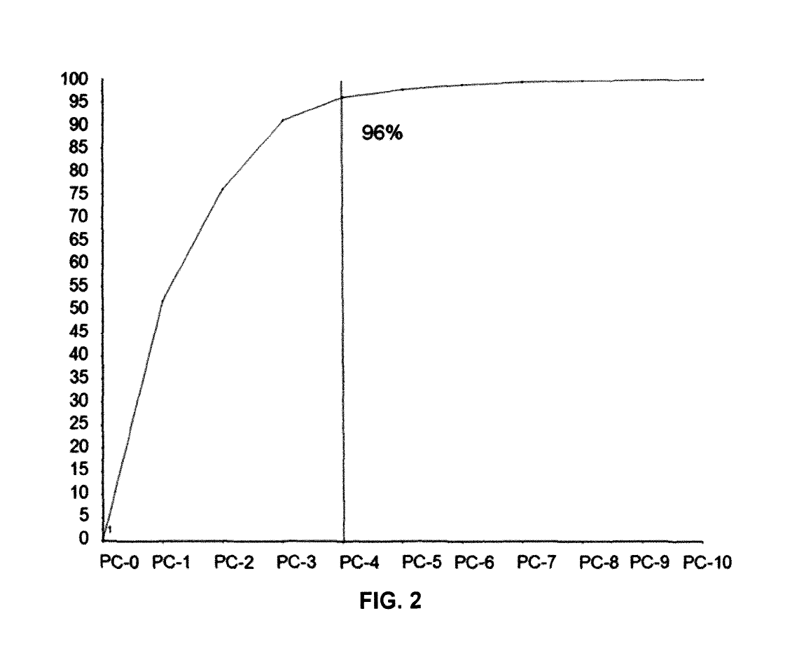

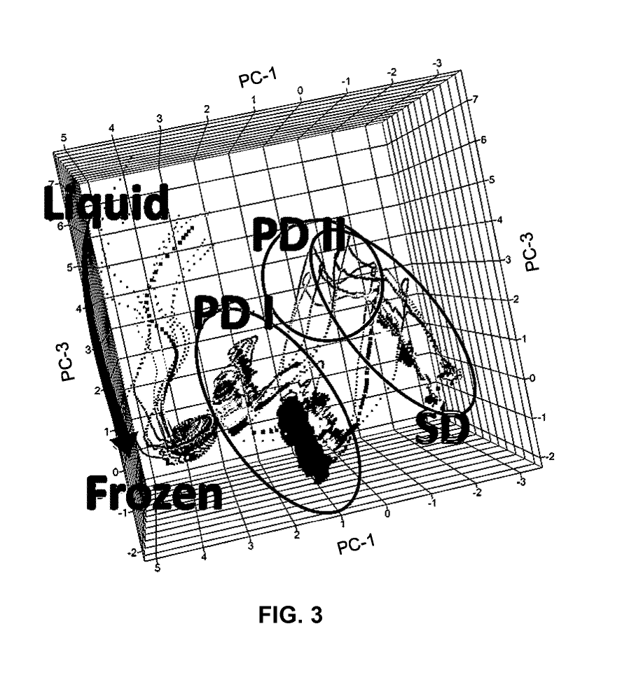

The calculated process fingerprint can be displayed as a graph of calculated scores of the obtained multivariate model. The number of significant principal components (and their scores) to be used for process fingerprinting depends on the explained variance. As can be seen from the graph of explained variance depicted in FIG. 2, the first four PCs of the example provided by FIG. 1 explain 96% of variation contained in the experimental dataset. If the explained variance is sufficiently high with just two principal components, it is possible to create a two dimensional control chart, showing a first principal component on one axis and a second principal component on another axis. If it is necessary to use at least 3 principal components to explain an acceptable degree of variance, a three dimensional graph can be constructed, with one principal component in each axis, as shown in FIG. 3.

As mentioned above, the selected variables are used to calculate the fingerprint of a process. So, additionally to the fingerprint of the optimal process and the fingerprint of the process carried out at the highest temperature and pressure yielding a product within specifications, it is possible to create a fingerprint for every process yielding a product batch (commercial process), namely for every freeze drying process susceptible of giving a product within specifications.

So, as mentioned above, in another aspect the invention also relates to a process for controlling the quality of a freeze-drying process which comprises: a) performing the freeze drying process at the temperature and pressure set points of the optimal process; b) obtaining a fingerprint of the process by carrying out a PCA on the selected variables mentioned above; and c) using the range of fingerprints obtained by the method as defined above in order to assess whether the product batch is within specifications by comparing the fingerprint of the process and the range of fingerprints obtained by the method as defined above, being the range of fingerprints defined by the fingerprint of the optimal process and the fingerprint of the process carried out at the at the highest temperature and pressure yielding a product within specifications.

Step c) of the process for controlling the quality of a freeze-drying process as defined above can be carried out by calculating the degree of match between the fingerprint of the process and the fingerprint of the optimal process and comparing it with the degree of match between the fingerprint of the optimal process and the fingerprint of the process carried out at the highest temperature and pressure yielding a product within specifications.

So, apart from comparing the graphs of scores, particularly, the degree of match between two fingerprints can be quantified by calculating the congruence coefficient between the matrices of scores of the two fingerprints.

Accordingly, In a particular embodiment, optionally in combination with one or more features of the particular embodiments defined above or below, step c) is carried out by calculating the congruence coefficient between the fingerprint of the process and the fingerprint of the optimal process and comparing it with the congruence coefficient between the fingerprint of the optimal process and the fingerprint of the process carried out at the highest temperature and pressure yielding a product within specifications.

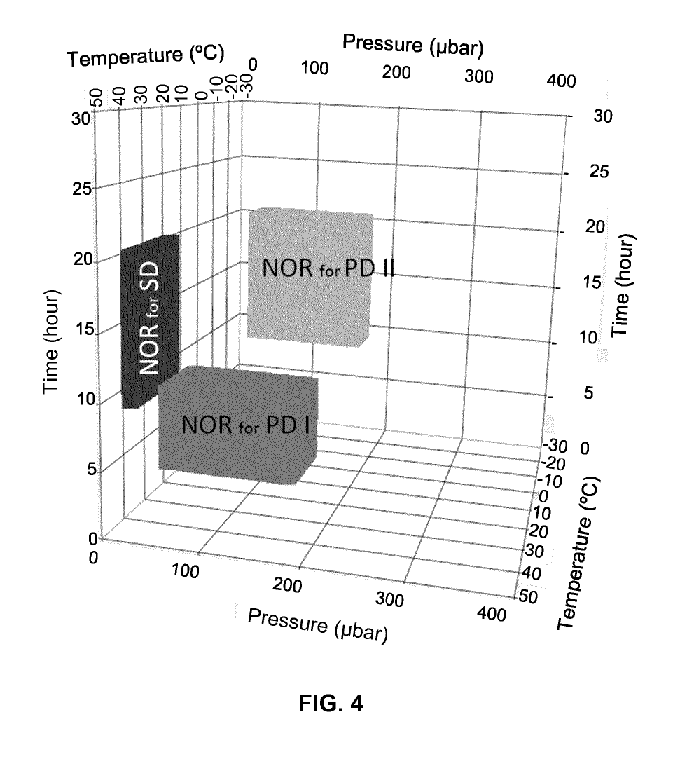

The congruence coefficient, quantifying the degree of similarity of the matrices (i.e. the degree of similarity between two configurations of points), can be calculated as explained in Hervé Abdi, 2010, “Congruence: Congruence coefficient, Rv-coefficient, and Mantel coefficient”, Encyclopedia of Research Design (Neil Salkind Ed.). The interval of acceptance for the congruence coefficient for every product batch is given by the congruence coefficient between the optimal and the most aggressive but still acceptable trajectory obtained during the development and engineering batches. All those batches that yield with a finished product that meets the quality criteria describe a normal operating range (NOR) for the set points of the input parameters, for each of the phases (see FIG. 4 for an example).

Particularly, if the congruence coefficient between the fingerprint of the process yielding the product batch and the fingerprint of the optimal process is equal to or higher than the congruence coefficient between the fingerprint of the optimal process and the fingerprint of the process carried out at the highest temperature and pressure yielding a product within specifications, then the freeze dried product will be within specifications. On the opposite, if the congruence coefficient between the fingerprint of the process yielding the product batch and the fingerprint of the optimal process is lower than the congruence coefficient between the fingerprint of the optimal process and the fingerprint of the process carried out at the highest temperature and pressure yielding a product within specifications, then the freeze dried product will not be within specifications.

Commercial software, such as MathCad Prime (PTC Inc.), can provide tools to calculate the congruence coefficients, following the instruction explained by Abdi in the cited reference.

If the process fingerprint has an acceptable degree of congruence with the optimal fingerprint, in a particular embodiment, multivariate analysis of the analytical data of the finished products allows obtaining formulas that can be used to predict some of the analytical data of a product batch without actually analyzing it. By an “acceptable degree of congruence” it is understood that the congruence coefficient between the assessed process and the optimal process is equal or superior to the congruence coefficient between the process carried out at the highest temperature and pressure and the optimal process. Accordingly, in a particular embodiment, optionally in combination with one or more features of the particular embodiments defined above, the process defined above further comprises a step d) wherein multivariate analysis of the analytical data of a freeze dried product within specifications is carried out in order to obtain formulas predicting some of the analytical data of a freeze dried product.

Multivariate analysis of the analytical data, in order to get the mentioned formulae, can be done with a statistical software that is capable of performing multivariate analysis for the adjustment of a prediction model based in some of the set points of the process. As an example, JMP (SAS) can be used.

The predicted analytical data is the one defining the critical attributes that determine the quality of the finished product (critical quality attributes). Thus, the result of the design of experiment is tackled with the matrix corresponding to the critical quality attributes in order to obtain an operator that establishes the correlation between critical process parameters and critical quality attributes.

Examples of the mentioned analytical data (critical quality attributes of the finished product) that can be predicted by the obtained formulas include the residual moisture content (RMC), and the reconstitution time. For these two parameters it will not be necessary to carry out the finished product analysis to release the batch. Accordingly, in a particular embodiment, the analytical data of the finished product is selected from the residual moisture content (RMC), and the reconstitution time.

An example of such approach is given for the residual moisture content, which is one of the critical quality attributes of the finished freeze dried product, by the following general formula:

RMC=A+Σ(Bᵢ×Fᵢ)+Σ(C_{g}×FF_{g})

wherein

A is the average value of RMC,

Bᵢ is a coefficient that multiplies the process parameter's value when it is considered without interactions,

C_{g} is a coefficient that multiplies the process parameter's value when it is considered with interactions,

F and F_{i-g} are values of a particular process parameter.

The formula includes just set up process parameters that are found to be significant, such as primary drying-I shelf temperature (TI), primary drying-II shelf temperature (TII), primary drying chamber pressure (P), secondary drying time (tII), and some significant combinations thereof. The obtained formula is using critical parameters from the set up for the process.

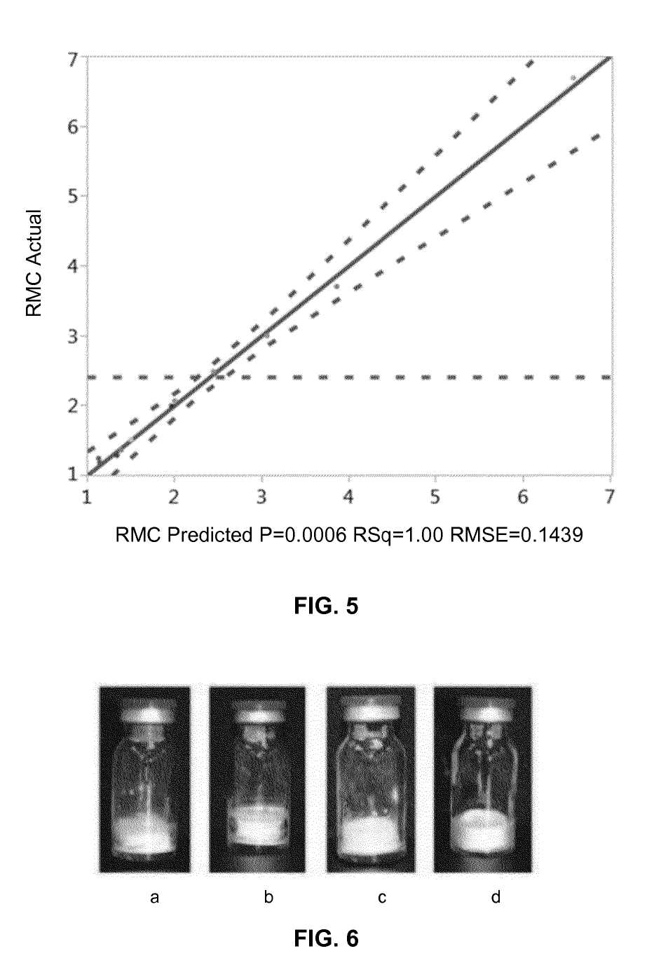

The formula is obtained by providing a range of results (one for each product batch) that have to be within specifications for the quality attribute of the product. Comparing the experimental results and the estimated results the linear regression should provide a regression coefficient according with the confidential level established. An example of a graphic output obtained for such a confirmation is showed in FIG. 5.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples and drawings are provided by way of illustration, and they are not intended to be limiting of the present invention. Furthermore, the present invention covers all possible combinations of particular embodiments described herein.

### EXAMPLE

This example discloses the general procedure to carry out the method of the invention on a freeze-drying process carried out for a pharmaceutical active ingredient. The method was carried out by performing the following steps:

1) A solution of a pharmaceutical active ingredient to be freeze dried was prepared by dissolving 250 mg of the active pharmaceutical ingredient in 2.8 ml of water for injection. In case it is necessary, the pH can be adjusted in order to stabilize the solution.

2) The total solidification temperature, the glass transition temperature and the collapse temperature of the solution were determined by Differential Scanning Calorimetry (DSC 823e, Mettler Toledo) and freeze drying microscopy (Olympus BX51+Linkam FDCS 196 Stage+LNP94/2+Lynksys software, Linkam Scientific Instruments Ltd). DSC was carried out within the range of temperatures from 25° C. to −100° C., a cooling rate of 10° C./min and a heating rate of 10° C./min.

3) The temperature and pressure set points for the starting freeze drying process were determined according to the thermal parameters of step 2).

4) A set of experiments was defined for the process of step 3) by using a D-optimal approach of design of experiments (DOE). The experimental matrix was created using the JMP version 7 (SAS) software.

5) 2.8 ml aliquots of the solution were dosed in 10 ml molded vials.

6) A freeze-drying process for each one of the experiments defined above was carried out in a freeze dryer.

7) A dataset for parameters from the freeze dryer was obtained and the data were smoothed and scaled. The smoothing was performed with a curve segment of 31 points.

9) Pre-treated data was analyzed by carrying out two PCAs in order to create a fingerprint of any one of the processes defined by each experiment.

11) The following critical quality attributes were analyzed for each product obtained from each one of the processes: residual moisture, appearance of the freeze dried product, and reconstitution time.

12) Using the analytical data obtained in step 11, the processes yielding a product within specifications were selected, and among them the optimal process and the more extreme one, namely the one carried out at the higher temperature and pressure.

13) The congruence coefficient between the optimal process and the more extreme one was determined.

14) Process yielding a product batch (commercial process) was carried out with the same temperature and pressure set points than the ones of the optimal process and its fingerprint was found.

15) The congruence coefficient between the optimal process and the process yielding the product batch was calculated. When the congruence coefficient was equal or superior to the one calculated in point 13, then the process resulted in a product within specifications (there will be no need to analyze the above mentioned quality attributes for that product).

16) if desired, a value (range) can be assigned to the mentioned attributes for one specific process (batch) by using the data of the regression line (predicted vs. measured data) calculated with the JMP version 7 software (See FIG. 5).

Thus, the following formula was obtained for the residual moisture content:

RMC=1.84−0.34(TI)+0.34(P)−0.22(P*TI)−0.25(TI*TII)−0.15 tII−0.09(TII)+0.05(P*TII)

wherein the formula includes just set up process parameters that are found to be significant, such as: primary drying-I shelf temperature (TI), primary drying-II shelf temperature (TII), primary drying chamber pressure (P), secondary drying time (tII) and some significant combinations thereof. In that case the obtained algorithm is a non-quadratic and non-linear fitting that is using critical parameters from the set up for the process.

For the appearance, a ranking of four categories was established as shown in FIG. 6. The residual moisture content should be under six per cent, being ideal results between two and three per cent. Reconstitution time should be less than two minutes, being ideal results less than one minute.

In step 9), a first PCA was carried out on the dataset shown in the Table 1 below:

TABLE 1

| | | | | PAT |
|---|---|---|---|---|
| | | | | or |
| Id | | Ref. QbD | Units | CPP |
| | Data (Signal response) | | | |
| 01 | dew point temperature | PRO | ° C. | PAT |
| 02 | Shelf Temperature | TBA | ° C. | CPP |
| 03 | Shelf Thermal Fluid Temp. (Inlet) | TEB | ° C. | |
| 04 | Shelf Thermal fluid Temp. (Outlet) | TSB | ° C. | |
| 05 | Condenser Temp. (Inlet) | TEC | ° C. | |
| 06 | Product Temperature #1 measured | TP1 | ° C. | |
| | by one temperature probe | | | |
| 07 | Product Temperature #2 measured | TP2 | ° C. | |
| | by another temperature probe | | | |
| 08 | Condenser Temp. (Outlet) | TSC | ° C. | |
| 09 | Chamber pressure (Capacitance | VBC | μbar | |
| | gauge) | | | |
| 10 | Pressure value at pump port | VPB | μbar | |
| | (Pirani gauge) | | | |
| 11 | Chamber pressure (Pirani gauge) | VPC | μbar | CPP |
| | Combined Parameters | | | |
| 12 | Shelf Temp - Product Temp #1 | TP1_TBA | ° C. | PAT |
| | | | | (2nd) |
| 13 | Shelf Temp - Product Temp #2 | TP2_TBA | ° C. | PAT |
| | | | | (2nd) |
| 14 | Shelf Thermal Fluid Temp. (Inlet - | TEB_TSB | ° C. | PAT |
| | Outlet) | | | (2nd) |
| 15 | Condenser Temp. (Inlet-Outlet) | TEC_TSC | ° C. | |
| 16 | Chamb.Vac. Ratio | VBC_VPC | NA | PAT |
| | (Capacitance/Pirani) | | | (2nd) |
| 17 | Relative Chamb.Vac. Ratio | VBC_VPC_R | NA | |
| 18 | Vac. Ratio between | VPB_VPC | NA | |
| | Pump/Chamber | | | |
| 19 | Relative Vac. Ratio Pump vs | VPB_VPC_R | NA | |
| | Chamb. | | | |
| 20 | Chamb. Vac. Diff. (Capacitance - | VBC_VPC_Dif | μbar | PAT |
| | Pirani) | | | (2nd) |

TP1_TBA, TP1_TBA: difference between shelf temperature and product temperature;
TEB_TSB: difference between shelf thermal fluid inlet and out temperatures;
TEC_TSC: difference between condenser inlet temperature and outlet temperature;
VBC_VPC_Dif: difference between chamber pressures measured by two types of gauges, VBC-VPC;
VBC_VPC: ratio between the chamber pressure values measured by two types of gauges, VBC/VPC;
VBC_VPC_R: difference, relative to the chamber pressure value measured by a Pirani gauge, between the chamber pressure value measured by one capacitance gauge and the chamber pressure value measured by a Pirani type gauge, (VBC-VPC)/VPC;
VPB_VPC: ratio between the pressure at pump port and the chamber pressure (both measured by Pirani type gauge), VPB/VPC;
VPB_VPC_R: difference, relative to the chamber pressure value measured by a Pirani gauge, between the pressure at pump port and the chamber pressure measured by a Pirani type gauge, (VPB-VPC)/VPC;
NA = non-applicable;
PAT = Parameter obtained by a Process Analytical Technology;
PAT (2nd) = Secondary PAT, i.e. a non-PAT parameter but is a derived parameter behaving as a PAT parameter;
CPP = Critical Process Parameters, i.e. set-up parameters;

After eliminating both parameters with loading values close to zero and parameters having the same loading value as another one, the second PCA was carried out on the following selected parameters:

TABLE 2

| | | | | PAT or | CONFIRMED |
|---|---|---|---|---|---|
| Id | Data (Direct & Combined) | Ref. QbD | Units | CPP | RELEVANCE |
| 01 | Dew point temperature | PRO | ° C. | PAT | Yes |
| 02 | Shelf Temperature | TBA | ° C. | CPP | CONTROL |
| 03 | Shelf Thermal Fluid Temp. | TEB | ° C. | | Yes |
| | (Inlet) | | | | |
| 06 | Product Temperature #1 | TP1 | ° C. | | Yes |
| 07 | Product Temperature #2 | TP2 | ° C. | | Yes |
| 09 | Chamber Vacuum | VBC | μbar | | Yes |
| | (Capacitance gauge) | | | | |
| 11 | Chamber Vacuum (Pirani | VPC | μbar | CPP | CONTROL |
| | gauge) | | | | |
| 12 | Shelf Temp - Product Temp #1 | TP1_TBA | ° C. | PAT | Yes |
| | | | | (2nd) | |
| 13 | Shelf Temp - Product Temp #2 | TP2_TBA | ° C. | PAT | Yes |
| | | | | (2nd) | |
| 14 | Thermal Fluid Temp. (Inlet- | TEB_TSB | ° C. | PAT | Yes |
| | Outlet) | | | (2nd) | |
| 16 | Chamb.Vac. Ratio | VBC_VPC | NA | PAT | Yes |
| | (Capacitance/Pirani) | | | (2nd) | |
| 20 | Chamb. Vac. Diff.(Absolute- | VBC_VPC_Dif | μbar | PAT | Yes |
| | Pirani) | | | (2nd) | |
| 21 | Dew point | PRO | ° C. | PAT | Yes |

This reduced group of parameters were the ones useful for the construction of the process fingerprint.

FIG. 1 depicts the graph of loadings provided for the first 4 PC. As can be seen, the parameters TP1 and TP2, as well as TP1_TBA and TP2_TBA provide the same information. Therefore, for the process fingerprint calculation, just one of each group could be used.

### REFERENCES CITED IN THE APPLICATION

1. WO2007018868

2. WO2011077390

3. A. Savitzky, et al. “Smoothing and differentiation of data by simplified least squares procedures” Anal. Chem., 1964, Vol. 36, pp. 1627-1639

4. J. Steinier, et al. “Comments on smoothing and differentiation of data by simplified least square procedure”, Anal. Chem., 1972, Vol. 44, pp. 1906-1909

5. Hervé Abdi, 2010, “Congruence: Congruence coefficient, Rv-coefficient, and Mantel coefficient”, Encyclopedia of Research Design (Neil Salkind Ed

1. A method for obtaining a range of fingerprints defining the quality of a freeze-drying process, comprising the steps of:
i) providing a product to be freeze dried;
ii) fixing the temperature and pressure set points for the freeze drying process;
iii) defining a set of experiments by statistical design of experiments (DoE) for the freeze drying process in order to introduce variability in the process and to study their influence on the quality of the obtained freeze dried product;
iv) performing a freeze drying process of the product of step i) for each one of the experiments defined in step iii) using a freeze dryer;
v) obtaining a dataset of pressures and temperatures from the freeze dryer, wherein the dataset of pressures and temperatures from the freeze dryer comprises at least one combined parameter;
vi) removing noise intrinsic to the measurements from the dataset in order to obtain smoothed data by using computational methods, and scaling the smoothed data;
vii) performing a first multivariate analysis on the smoothed and scaled data by using Principal Component Analysis (PCA) to obtain a first set of principal components;
viii) analysing the first set of principal components in order to select a set of parameters by eliminating parameters with loading values close to zero and parameters having the same loading value as another parameter, and carrying out a second multivariate analysis by using PCA on the selected parameters to obtain a second set of principal components;
ix) selecting a number of principal components explaining a variance equal to or higher than 95% of the total variance of the dataset to obtain a fingerprint of the freeze drying process for each one of the experiments carried out in step iii);
x) analysing the quality of the freeze dried product obtained by each one of the experiments carried out in step iii) in order to see if the product is within specifications; and
xi) selecting the fingerprint of the process yielding the finished product with the best analytical profile, and the fingerprint of the process carried out at the highest temperature and pressure yielding a product within specifications, both fingerprints defining a range of fingerprints in which a specific product batch will be within specifications.

2. The method according to claim 1, wherein the product to be freeze dried is provided in the form of a solution, and the temperature and pressure set points for the freeze drying process are fixed according to the following thermal parameters: total solidification temperature of the solution; the glass transition temperature of the product in the case of an amorphous product, or alternatively, the eutectic melting temperature of the product in the case of a crystalline product; and the collapse temperature of the maximally freeze-concentrated solute.

3. The method according to claim 1, wherein at least one combined parameter in step v) is the ratio between the chamber pressure values measured by two types of gauges.

4. The method according to claim 3, wherein the dataset of step v) further comprises the following combined parameters: the difference between shelf and product temperatures; the difference between condenser inlet and outlet temperatures; the difference between shelf thermal fluid inlet and outlet temperatures; difference, relative to the chamber pressure value measured by a Pirani gauge, between the chamber pressure value measured by one capacitance gauge and the chamber pressure value measured by a Pirani type gauge; the ratio between the pressure at pump port and the chamber pressure; difference, relative to the chamber pressure value measured by a Pirani gauge, between the pressure at pump port and the chamber pressure measured by a Pirani type gauge; and the difference between the chamber pressure values measured by two types of gauges.

5. The method according to claim 4, wherein the pressure at pump port and the chamber pressure in the ratio between the pressure at pump port and the chamber pressure, and the ratio between the pressure at pump port and the chamber pressure relative to chamber pressure, are measured by a Pirani type gauge.

6. The method according to claim 1, wherein the dataset of step v) comprises the following parameters: chamber pressure measured by two different types of gauges, and shelf thermal fluid inlet temperature.

7. The method according to claim 6, wherein the dataset of step v) further comprises the following parameters: pressure at pump port, shelf thermal fluid outlet temperature, condenser inlet and outlet temperatures, shelf surface temperature and product temperature measured by at least one temperature probe.

8. The method according to claim 7, wherein the dataset of step v) further comprises the dew point temperature.

9. A process for controlling the quality of a freeze-drying process, comprising:
a) performing the freeze drying process at the temperature and pressure set points of the process yielding the finished product with the best analytical profile as defined by the method of claim 1;
b) obtaining a fingerprint of the process by:
i) carrying out a multivariate analysis by using PCA on the parameters selected in step viii) of the method of claim 1 to obtain a set of principal components; and
ii) selecting the same number of principal components as defined in step ix) of the method of claim 1; and
c) using the range of fingerprints obtained by the method of claim 1 in order to assess whether the product batch is within specifications by comparing the fingerprint of the process and the range of fingerprints obtained by the method of claim 1.

10. The process according to claim 9, wherein step c) is carried out by calculating the congruence coefficient between the fingerprint of the process and the fingerprint of the optimal process and comparing it with the congruence coefficient between the fingerprint of the optimal process and the fingerprint of the process carried out at the highest temperature and pressure yielding a product within specifications.

11. The process according to claim 10, wherein when the congruence coefficient between the fingerprint of the process and the fingerprint of the optimal process is equal to or higher than the congruence coefficient between the optimal process and the process carried out at the highest temperature and pressure yielding a product within specifications, then the freeze dried product is within specifications.

12. The process according to claim 9, further comprising a step d) wherein multivariate analysis of the analytical data of a freeze dried product within specifications is carried out in order to obtain formulas predicting some of the analytical data of a freeze dried product.

13. The process according to claim 9, wherein the product to be freeze-dried is a pharmaceutical active ingredient.

14. The method of claim 1, wherein in step v) the dataset of pressures and temperatures is obtained from the freeze dryer and from at least one probe measuring additional information about the process or the product.

15. The method according to claim 2, wherein at least one combined parameter in step v) is the ratio between the chamber pressure values measured by two types of gauges.

16. The process according to claim 10, further comprising a step d) wherein multivariate analysis of the analytical data of a freeze dried product within specifications is carried out in order to obtain formulas predicting some of the analytical data of a freeze dried product.

17. The process according to claim 11, further comprising a step d) wherein multivariate analysis of the analytical data of a freeze dried product within specifications is carried out in order to obtain formulas predicting some of the analytical data of a freeze dried product.
